(19) United States
(12) Patent Application Publication
(10) Pub. No.: US 2007/0159110 A1
(43) Pub. Date: Jul. 12, 2007

(54) Shoe lamp device with multiple voltage levels

(76) Inventor: Ming Bi Weng, Taipei (TW)

Correspondence Address: Ming Bi Weng, P.O.Box 166-13, Taipei, 115, TW

(21) Appl. No.: 11/707,976

(22) Filed: Feb. 20, 2007

Related U.S. Application Data
(63) Continuation-in-part of application No. 10/889,617, filed on Jul. 13, 2004.

(51) Int. Cl. F21S 4/00

(52) U.S. Cl. 315/185 S

(57) ABSTRACT

A shoe lamp device with multiple voltage levels by using a power supply having a voltage above 4.5 V batteries for supplying power to color light emitting diodes; a vibration switch for generating a trigger signal; and a substrate having an IC control circuit; the substrate being electrically connected to the color light emitting diodes through conductive wires; a switch for activating a CY pin, of which two duty control pins can be applied to select pulse duration of a pulse period; when the circuit receiving a trigger signal, it will generate a driving signal to drive the single color light emitting diodes according to the ½, ¼, ⅛ pulse duration to flash in a predetermined sequence. The voltage of the power supply is 4.5 V (volts) which is formed by serially connecting two batteries of 1.5V and 3.0V, respectively or the two batteries of 3.0V and 3.0V, respectively.

### CROSS REFERENCE TO RELATED APPLICATION

The invention is C-I-P application of U.S. application Ser. No. 10/889,617 filed on Jul. 13, 2004.

### FIELD OF THE INVENTION

The present invention relates to shoes with light emitting diodes (LEDs), and particular to a shoe lamp device with multiple voltage levels, which are driven by two different voltage levels so as to present different flash effect; and, both 3 V batteries connected in series operated in a power saved mode is the LEDs flashed in a selected pulse duration of ½, or ¼ pulse period of a pulse modulated wave (PMW).

### BACKGROUND OF THE INVENTION

In the prior art U.S. Pat. No. 6,525,487 entitled “light driver for shoe” assigned to Wei, Meng-Pi, the inventor of the present invention on Feb. 25, 2003, in that the power supply of a shoe is formed by a first battery of 1.5V and a second battery of 3.0V. The first and second batteries are serially connected so as to have a voltage of 4.5V which can afford voltages of 3.0 V and 4.5V to light emitting diodes.

The wavelength of visual light is from 4000 to 7000 angstroms (1A°=10⁻⁸ cm=10⁻⁴ micrometer). In general, the wavelength of purple light is between 4,000˜4,500 angstrom, the wavelength of blue light is between 4,500˜5,200 angstrom, the wavelength of green light is between 5,200˜5,600 angstroms, the wavelength of yellow light is between 5,600˜6,000, the wavelength of original light is between 6,000˜6,250 angstrom, and the wavelength of red light is between 6,250˜7,000 angstrom. Voltage of 3.0V serves to light up the light emitting diodes of red color, orange color, green color, etc., and voltage above 4.5V serves for lighting up the light emitting diodes of blue color, purple color, pink color, white color, etc. because the lighting emitting diode emitting these colors need high voltages to drive them so as to emit lights with sufficient strengths.

Through experiences of many times, it is discovered that if a voltage above 4.5V, for example, 6.0V is used to drive the light emitting diodes of blue color, purple color, pink color, white color, etc., then these diodes can emit lights with stronger strengths than the result got by using a voltage of 4.5V, and a voltage of 4.5V is supplied to the light emitting diodes of red color, orange color, green color, etc., then the emit lights have strengths and effects preferred than those used in the prior art.

Although in the U.S. Pat. No. 6,525,487, a voltage above 4.5 V such as 6 V is not claimed, but claimed in the U.S. application Ser. No. 10/889,617 by the same inventor now is incorporated into the present invention.

Compared with prior arts, the present invention can be improved based on the abandoned U.S. application Ser. No. 10/889617, such as U.S. Pat. No. 7,004,598 assigned to Wai-Kai Wong on Feb. 28, 2006, a CMOS (Complementary Metal Oxide Semiconductor) controller may require a power supply of 5 V, the threshold is 2.5 V, the 1 range is from 3.5 V up to 5 V, which is higher than the logic levels of popular TTL (Transistor Transistor Logic) and ECL (Emitter Coupled Logic). (please see pages 12-13 of Understanding Digital Troubleshooting by Den L. Cannon published by Texas Instruments Incorporated 1983, 1984) Further illustrated in FIG. 3 of '598, the supply transistors 34b with a PNP configuration are controlled by control transistors 34a with a NPN configuration, transistors 33a, 33b with a NPN configuration route voltages V2, V3 to LED 39a. As a result, a higher resistance be detected in PNP transistor by a multi-meter, or it will be NPN transistor. Reducing heat-sensitivity caused by leakage current I_{CBO} (with heat) from collector to base, a PNP in connection with NPN transistors is a conventional art. Since CMOS is also sensitive to the static voltage so that vibrations and shocks more severe than allowed will cause fatal damage to the device as aluminum alloy only partly deployed on CMOS. Heat sinks are still required for transistors as well as an anti-static mat is still required for CMOS, and a static sensitive CMOS must be careful of the handling as following points: do not directly touch it unnecessarily, but place it on something soft, careful not to apply an excessive force on it when removing shock-absorbing material and so on with it. When manufacturing, shoe lamps made of CMOS or a number of transistors may occupy a bulky space as if they became too expensive to shine.

Based on U.S. Pat. No. 4,848,009 to Rogers on Jul. 18, 1989, U.S. Pat. No. 5,457,900 to Roy et al. on Oct. 17, 1995 disclosed a plurality of light emitting diodes (LEDs) display a graphic message shown in a non-random sequence, when walking at a rate. During which, LEDs are switchable between a light emitting or dormant state further minimizing the surface area of lighting, but each LED is lit independently of each other. Such a non-random sequence is defined as fixed locations of LEDs connected to the printed circuit board (PCB) via resistors respectively in one to one relationship as shown in FIG. 7 of '900 thus to flash 12 times in one rush step. LEDs must be arrayed in a lineated order by a “design” effort; or a monotonous message accompanied by different pace steps—such as one pace forward or one pace step back—interference of the ambient light may dim the LEDs. Further, power transferred into heat by resistors or diodes may overheat the graphic surface or PCB. Once batteries run down, or parts of LEDs are not responsive to the “non-random” sequence, it shows uncontrollably dim or discolored “message”. “Also, the parallel arrangement of rows is a fail-safe measure that ensures that the light module 100 will still function even if a single LED in a row fails, thus opening the electrical circuit in that row.” disclosed in U.S. Pat. No. 6,018,038 col. 3 lines 41-44 is improved than '009.

In U.S. Pat. No. 6,016,038 to Mueller et al. on Jan. 18, 2000, he taught that using pulse-width modulated signals (PWM) alter the generated color and brightness of LEDs. Combining light colors of two LEDs may result in a third color. Three primary colors—red, blue and green—can be combined in different proportions to generate almost any color in the visible spectrum is surely known as U.S. Pat. No. 5,420.482 to Parel on May 30, 1995, while U.S. Pat. No. 4,845,481 to Havel on Jul. 04, 1989 uses a pulse width modulated signal to provide current to respective LEDs at a particular duty cycle. As pulse width modulated signals were not attributed to a save power mode in '038, while they turned out to be mixing colors among each 256 colors in RGB primary colors by counters.

The various objects and advantages of the present invention will be more readily understood from the following detailed description when read in conjunction with the appended drawing.

### SUMMARY OF THE INVENTION

Accordingly, the primary object of the present invention is to provide a shoe lamp device with multiple voltage levels, a voltage of 6.0V is used to drive the light emitting diodes of blue color, purple color, pink color, white color, etc., then these diodes can emit lights with stronger strengths than the result got by using a voltage of 4.5V, and a voltage of 3V is supplied to the light emitting diodes of red color, orange color, green color, etc., then the emit lights have strengths and effects preferred than those used in the prior art.

To achieve above objects, the present invention provides a shoe lamp device with multiple voltage levels which comprises a plurality of single color light emitting diodes; at least one diode emitting light with wavelength below 5200 angstrom (AÅ) by using a power supply having a voltage above 4.5 V; a power source including batteries for supplying power to the single color light emitting diodes; a vibration switch for generating a trigger signal when the vibration switch vibrates; and a substrate having an IC control circuit; the substrate being electrically connected to the single color light emitting diodes through conductive wires; when the circuit receiving a trigger signal, it will generate a driving signal to drive the single color light emitting diodes to flash according to a predetermined sequence. The voltage of the power supply is 4.5 V (volts) which is formed by serially connecting two batteries of 1.5V and 3.0V, respectively. or the two batteries of 3.0V and 3.0V, respectively. Since two batteries connected in series must be consumed by a sequence of flashing light, thereby, a pair of duty control pins instead of CY (cycle) pin 9 added to the circuit serves for options of duty cycle from 1 full cycle to ½, 1/4 or ⅛ to save more power, since the flashing sequence is flashed in several millionth seconds, the save mode duty cycles could not be felt by the human eyes.

Due to the duty cycle is selected by two pins of CY pin 9, a pulse duration of a flashing sequence has been down-size to ½, 1/4, or ⅛ pulse period PWM, thereby, the time is delayed as 2 times, 4 times or 8 times other than a real flashing sequence duration. But the power is saved. In other words, a flashing sequence is only to electrify ¼ or ½ pulse period of a normal flashing sequence.

But the CY pin 9 is connected to the IC control circuit by a switch, only to close the switch, the CY pin 9 can be in application by the user.

### BRIEF DESCRIPTION OF THE DRAWINGS

FIG. 1 is a schematic perspective view of the first embodiment of the present invention.

FIG. 2 is a schematic perspective view of the second embodiment of the present invention.

FIG. 3 is a schematic perspective view of the third embodiment of the present invention.

FIG. 4 shows the circuit in the first embodiment of the present invention.

FIG. 5 is a circuit of the second embodiment of the present invention.

FIG. 6 shows the third circuit of the present invention.

FIG. 7 shows the circuit block diagram of the present invention.

FIG. 8 is a schematic view showing that the present invention is installed within a shoe.

### DETAILED DESCRIPTION OF THE INVENTION

In order that those skilled in the art can further understand the present invention, a description will be described in the following in detail. However, these descriptions and the appended drawings are only used to cause those skilled in the art to understand the objects, features, and characteristics of the present invention, but not to be used to confine the scope and spirit of the present invention defined in the appended claims.

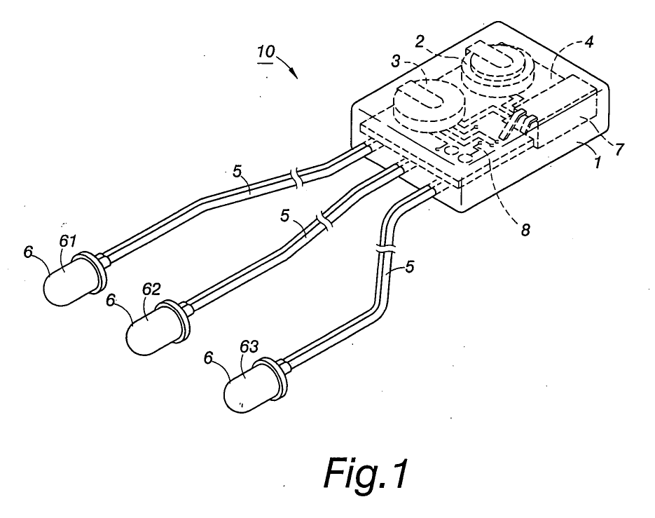

With reference to FIG. 1, the shoe lamp device with multiple voltage levels 10 of the present invention is illustrated. The shoe lamp device with multiple voltage levels 10 includes the following elements.

A plurality of single color light emitting diodes 6 are included as, at least one single color light emitting diode 6 emits light with wavelength below 5200 angstrom (AÅ) with a voltage above 4.5 V;

A power source including batteries 2, 3 serves for supplying power to the single color light emitting diodes 6.

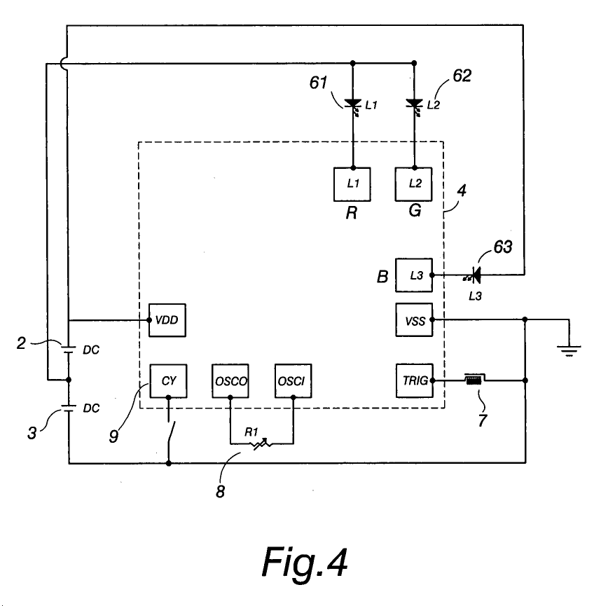

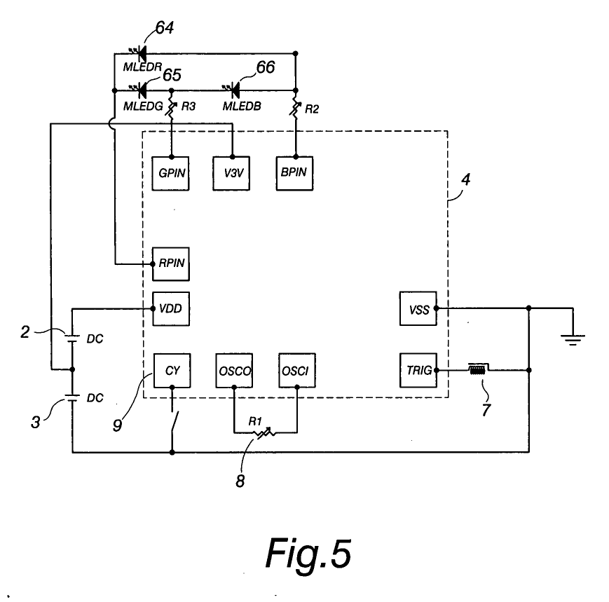

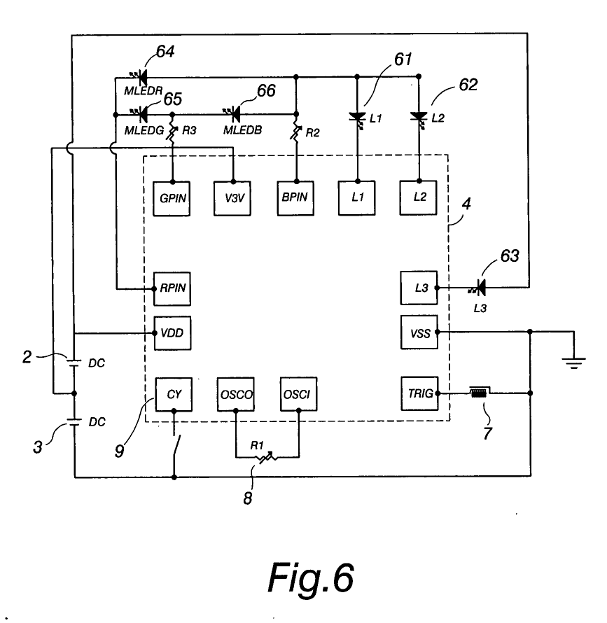

A vibration switch 7 serves for generating a trigger signal when the vibration switch 7 vibrates. Where a spring is connected between the trigger pin and the circuit as depicted in FIG. 4. While in FIGS. 5 and 6, two duty-control pins are assigned numeral 9 to a left lower corner of the circuit, where the duty-control pins already designated as CY (i.e. cycle) pin 9 in prior U.S. application Ser. No. 10/889,617, by which setting of flash sequences can be determined to meet different requirements of each batch of production, CY pin 9 should not be restricted to a trigger signal whether to shine once, twice or more times in a repeated manner; but two “duty-control” pins of CY pin 9, both of two duty control pins are assigned logic 1 and 0 when a high or low level voltage is detected respectively, both pins are thus designated to determine one full duty cycle, one half cycle, one fourth cycle or one eighth cycle of pulse duration of a pulse period to save power.

Due to the duty cycle is selected by two pins of CY pin 9, a pulse duration of a pulse period of a flashing sequence has held down to ½, 1/4, or ⅛ PWM, thereby, the time is delayed as 2 times, 4 times or 8 times other than a real flashing sequence duration. But the power is saved. In other words, a flashing sequence is only to electrify ⅛, ¼, 1/2 pulse period of a normal flashing sequence.

But the CY pin 9 is connected to the IC control circuit by a switch, only to close the switch; the CY pin 9 can be in application by the user.

Based on the experience of naked human eye's vision, any flashing sequence is quicker than 1/32 second; a lamp shoe with a full duty cycle is no different from a ½, 1/4, or ⅛ duty cycle. A persistence vision effect is retained. Only LEDs may shine less brightly but not an impressive mixing color is shown.

A substrate 4 has an IC control circuit and is electrically connected to the single color light emitting diodes 6 through the conductive wires 5. When the IC control circuit receives a trigger signal, it will generate a driving signal to drive the single color light emitting diodes 6 to flash according to a predetermined sequence. Such a sequence is decoded by a decoder following the counter of the IC control circuit, thereby, the selected pulse duration is directed to light the LEDs one by one in a predetermined sequence. But the LEDs are not to light at the same time.

The single color light emitting diodes 6 have various colors and are installed independently. In the drawing, the single color light emitting diode 61 is a red color light emitting diode. The single color light emitting diode 62 is a green color light emitting diode and the single color light emitting diode 63 is a blue color light emitting diode. Each single color light emitting diode 6 is connected to the substrate 4 through a pair of conductive wires 5 where the two wires are insulated from each other. The blue color light emitting diode 63 has wavelengths below 5200 angstrom by a power supply about 4.5 V.

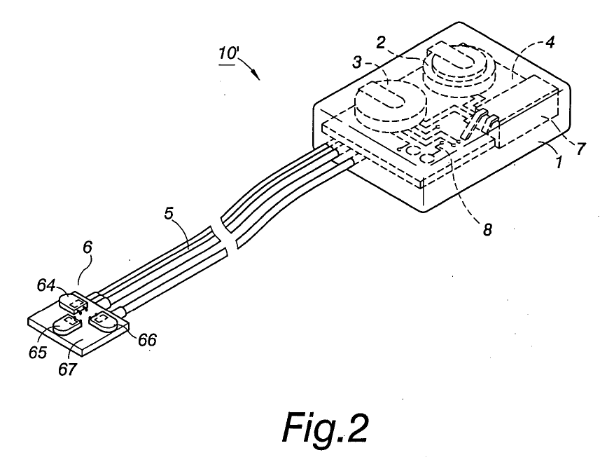

With reference to FIG. 2, the shoe lamp device with multiple voltage levels 10′ of the second embodiment of the present invention is illustrated. The difference of this embodiment from the previous one is that a plurality of single color light emitting diodes 6 with various colors are installed on one substrate 67. For example, a red color light emitting diode 64, a green color light emitting diode 65, and a blue color light emitting diode 66 are installed. The wavelength of the blue color light emitting diode is below 5200 angstrom by a power supply of 4.5 V. The three single color light emitting diodes 6 can present colors by emitting lights. The conductive wires 5 may be a wire bus, including data, instructions, and addresses can be transferred between the light emitting diodes 6 and the IC control circuit.

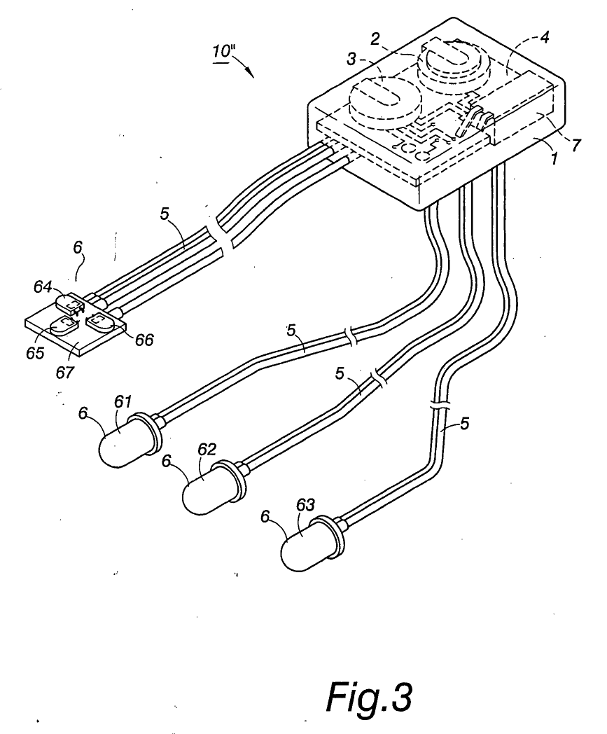

With reference to FIG. 3, the third embodiment of the shoe lamp device with multiple voltage levels 10″ according to the present invention is illustrated. In the present invention, there are two sets of single color light emitting diodes 6. One has the single color light emitting diodes 61 to 63 as those in the first embodiment and the other has the single color light emitting diodes 6 on one substrate as those in the second embodiment. The conductive wires 5 connecting the single color light emitting diodes 61 to 63 are individual wires 5 and the conductive wires 5 connecting the single color light emitting diode 64 to 66 on a wire bus.

With reference to FIG. 4, in the shoe lamp device with multiple voltage levels 10 of the first embodiment, the pins L1 to L3 are retained to the output pins of the single color light emitting diodes 61 to 63. The pin VDD is an anode with a DC of 3.0 Volt. The pin VSS is a cathode. The pin TRIG serves for triggering the vibration switch 7. The power source is formed by a first battery 2 of 3.0V and a second battery 3 of 1.5V so as to provide voltage levels of 3.0V and 4.5V to the substrate 4 and the single color light emitting diodes 61 to 63. The first voltage 2 is connected to the anodes of the red color light emitting diode 61 and the green color light emitting diode 62. The second battery 3 is connected to the anode of the blue color light emitting diode 63. Since the first battery 2 and the second battery 3 are serially connected to have a voltage of 4.5V. Thereby, a voltage level of 3.0V is provided to the red color light emitting diode 61 and the green color light emitting diode 62 and a voltage level of 4.5V is provided to the blue color light emitting diode 63.

Similarly, when a first battery of 3.0 V and a second battery of 3.0 V are serially connected. Then voltages of 3.0 V and 6.0V are provided. That is, the first battery 2 is electrically connected to the anodes of the red color light emitting diode 61 and the green color light emitting diode 62. The second battery 3 is electrically connected to the anode of the blue color light emitting diode 63. Since the first battery 2 and the second battery 3 are serially connected to have a voltage of 6.0V. Thereby, a voltage level of 3.0V is provided to the red color light emitting diode 61 and the green color light emitting diode 62 and a voltage level of 6.0V is provided to the blue color light emitting diode 63.

In the second embodiment, see FIG. 5, the pins BPIN, GPIN, and RPIN are connected to the single color light emitting diodes 64, 65 and 66. The pin V3V is an anode of a DC of 3.0 volt. The pin VDD is an anode of 4.5 volt (or 6.0 volt). The pin VSS is a cathode of the power source. The CY pin 9 serves for duty (cycle) control. Besides, the single color light emitting diodes 64-66 provide colors by the persistence vision effect.

As known, two batteries connected in series as being depicted in the present invention; eventually, a first battery in serial arrangement in the present invention and U.S. Pat. No. 6,525,487 may be consumed faster than the other. A duty cycle of ½, or ¼ or ⅛ duration of a pulse period of pulse modulated wave (PMW) selected by two “duty control” pins of “CY” (i.e. cycle) pin 9 saving power for the LEDs flashing color lights.

It is, every period of PWM is to reset a first counter, which increments periodically, thereby the duty control pins of CY pin 9 set the counter number such as from 1 to increment to 2, to 4 or to 8 (or from 0 to 1, 3, 7). According to the increments on counter, once it reaches 2 (or 1), the IC control circuit stops to electrify the LEDs. But LEDs can be optionally lit in a full cycle or transient ½, 1/4, or ⅛ pulse duration of a pulse period. A predetermined sequence is decoded by a decoder follows the counter, according to numbers of LEDs from a first LED to the last one. For example, when lit, unless they are common cathode (CC) or common anode (CA) LEDs connected together, they are lit one by one in order in a predetermined sequence. For example, the counter increments based on a transient from 0 to 1 and then 1 to 0 when duty cycle sets ½. Such LEDs shine less brightly and the power is saved. Both counter and decoder serve as dividers for clock signals. For example, five LEDs are turned on in a successive sections, but not to light at the same time. Since the tranient ½, 1/4, or ⅛ pulse duration is already directed to the LEDs successive sections, therefore, each LED is lit in a pulse duration less or equal to 1/20 pulse period, all of the successive sections are shorter than 1/32 second, thereby, a persistence of vision is kept in user's eyesight where a user only feels the LEDs shine less brightly but power is saved. It is assumed that preferrably ½ or ¼ duty cycle is sufficient bright to save power. A switch is connected between the CY pin and the IC control circuit, when closed, two duty control pins can be selected to determine a duty cycle, or the LEDs lit in full cycle pulse period.

But the CY pin 9 is connected to the IC control circuit by a switch, only to close the switch, the CY pin 9 can be in selection by the user.

With reference to FIG. 6, in the third embodiment, the pins L1 to L3 are used for the output pins of single color light emitting diodes 61 to 63, the pins BPIN, GPIN, and RPIN are connected to the single color light emitting diodes 64, 65 and 66 on a substrate. The pin V3V is an anode of a DC of 3.0 volt. The pin VDD is an anode of 4.5 volt (or 6.0 volt). The pin VSS is a cathode of the power source. The pin TRIG serves for the single shot triggering or level triggering the vibration switch 7. The pin CY serves for options of duty cycle control. Pins OSCI and OSCO are I/O (input/output) of an oscillator 8 connecting an external resistor R1, the pulse is changed.

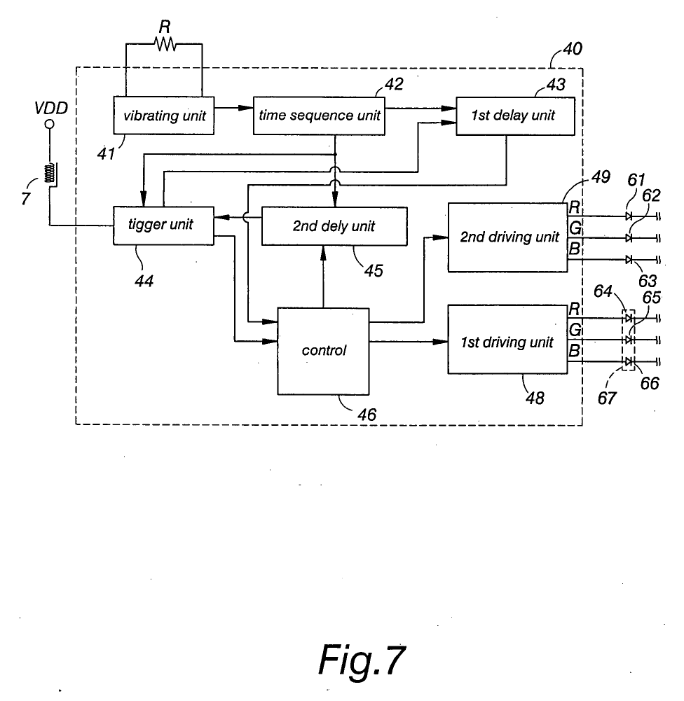

The IC control circuit 40 used in the third embodiment is illustrated in FIG. 7. The circuit is formed by a vibrating unit 41, a time sequence unit 42, a first delay unit 43, a trigger unit 44, a second delay unit 45, a control unit 46 and a first driving unit 48 for showing colors by LEDs on a substrate emitting lights successively in a transient pulse duration of a pulse period; and a second driving unit 49 for driving the single color light emitting diodes individually.

Accordingly, both a first and a second delay units 43, 45 are used to light LEDs in a predetermined sequence but not upon triggering to emit all LEDs at once.

The vibration unit 41 and the time sequence unit 42 serve to generate work frequencies to the first delay unit 43, the trigger unit 44 and the second delay unit 45. The trigger unit 44 is connected to the vibrating switch 7. When the vibration switch 7 vibrates, a first trigger signal is generated to the first delay unit 45 and the control unit 46. The first delay unit 43 serves to cause the IC control circuit 40 to delay the driving signals to the single color light emitting diode 61, 62, 63 and the single color light emitting diodes 64 to 66. Due to the duty cycle is changing by a selectable CY pin 9, the time is also delayed as 2 times, 4 times or 8 times but only shine one time as the power is saved. In the flash time period, if no new triggering signal is generated, the control unit 46 is disabled.

When the substrate 4 vibrates, the trigger unit 44 generates a trigger signal to the control unit 46. The control unit 46 sends driving signals to the single color light emitting diodes 61 to 63 and the single color light emitting diodes 64 to 66 after a delay time which is determined by the second delay unit 43. At this time, these single color light emitting diodes 61 to 66 flash according to the flash time sequence determined by the second delay unit 45.

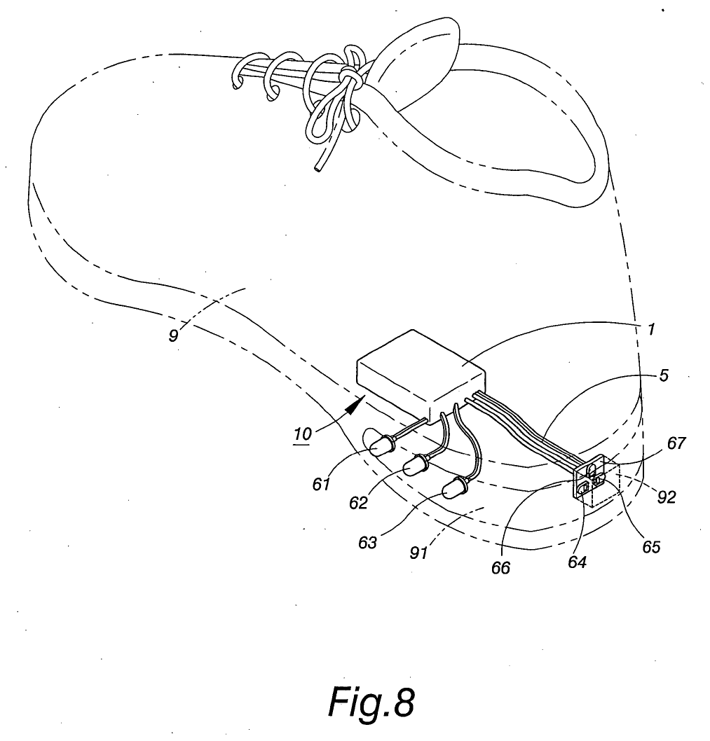

With reference to FIG. 8, it is illustrated that the present invention is installed within a shoe body 9. The light emitting diodes are installed at the periphery of the shoe. The single color light emitting diodes 61 to 63 can flash along various sequences or the single color light emitting diodes 64 to 66 can present various colors by showing of the lights of different colors.

The power supply, vibration switch and IC circuit are assembled in a casing and the single color light emitting diodes are installed at a shoe which can be seen from outer side of the shoe.

What is claimed is:

1. A shoe lamp device with multiple voltage levels comprising:
a plurality of single color light emitting diodes; at least one single color light emitting diode emitting light with wavelength below 5200 angstrom (AÅ) by using a power supply having a voltage above 4.5 V;
a power source including batteries for supplying power to the single color light emitting diodes;
a vibration switch for generating a trigger signal when the vibration switch vibrates;
a substrate having an IC control circuit; the substrate being electrically connected to the single color light emitting diodes through conductive wires; when the circuit receiving a trigger signal, it will generate a driving signal to drive the single color light emitting diodes to flash according to a predetermined sequence;
wherein the at least one single color light emitting diode emitting light with wavelength below 5200 angstrom (AÅ) by using a power supply having a voltage above 4.5 V emits light selected from one of purple light, pink and green light; but a CY pin with two duty control pins connected to the IC control circuit and operated by a switch, when the switch is closed, two duty control pins can be selected to save power in a ½, 1/4, duty cycle PWM (pulse width modulated signal).

2. The shoe lamp device with multiple voltage levels as claimed in claim 1, wherein a voltage of the power supply is 4.5 V (volts) which is formed by serially connecting two batteries of 1.5V and 3.0V, respectively.

3. The shoe lamp device with multiple voltage levels as claimed in claim 1, wherein a voltage of the power supply is 6.0 V (volts) which is formed by serially connecting two batteries of 3.0V and 3.0V, respectively.

4. The shoe lamp device with multiple voltage levels as claimed in claim 1, wherein the single color light emitting diodes flash along the positions of the single color light emitting diodes.

5. The shoe lamp device with multiple voltage levels as claimed in claim 1, wherein the flashed sequences are according to the duty cycle to emit light further in a pulse duration one eighth cycle of a pulse period.

6. The shoe lamp device with multiple voltage levels as claimed in claim 1, wherein the power supply, vibration switch and IC circuit are assembled in a casing and the single color light emitting diodes are installed at a shoe which can be seen from outer side of the shoe.

7. The shoe lamp device with multiple voltage levels as claimed in claim 1, wherein a plurality of single color light emitting diodes are installed on a substrate.

8. The shoe lamp device with multiple voltage levels as claimed in claim 1, wherein the plurality of single color light emitting diodes are installed on different substrates.
